(19) United States
(12) Patent Application Publication
(10) Pub. No.: US 2026/0300983 A1
(43) Pub. Date: Oct. 1, 2026

(54) AUTOMATED FRAUD DETECTION

(71) Applicant: PointPredictive Inc., San Diego, CA (US)

(72) Inventors: Darren Thomas, San Diego, CA (US); Vikram Gunasekar, San Diego, CA (US); Dylan Petersen, San Diego, CA (US); William Hall, San Diego, CA (US); Timothy J. Grace, Encinitas, CA (US); Frank J. McKenna, La Jolla, CA (US)

(73) Assignee: PointPredictive Inc., San Diego, CA (US)

(21) Appl. No.: 19/097,623

(22) Filed: Apr. 1, 2025

(51) Int. Cl. G06Q 20/40

(52) U.S. Cl. CPC G06Q 20/4016

(57) ABSTRACT

Systems and methods for automated fraud detection are disclosed herein. One aspect of the present relates to a method for computing an application score, this includes receiving, by a computer system, an application object for an application, extracting information from the application, capturing features from pooled data across time and lenders, ingesting the captured features into a Recurrent Neural Network (“RNN”), generating a preliminary risk score with the RNN based on the ingested captured features, scaling the preliminary risk score to a range of application scores to determine the application score for the application, determining one or more reason codes for the application based at least in part on the application score for the application, and providing the application score and the one or more reason codes to a dealer user device or a lender user device. The application object can include application data associated with a first borrower.

### BACKGROUND

The present disclosure relates generally to improving electronic authentication and reducing risk of electronic transmissions between multiple sources using multiple communication networks.

Fraud can be prevalent in any context or industry. Customary verification techniques may rely on various forms of documentation to confirm an identity of or verify personal data (e.g., age, address, occupation) related to a person. However, when these verification requirements are implemented in an electronic environment, electronic authentication becomes an even more difficult problem to solve. For example, the documentation may be difficult to locate, or electronic versions of the documentation may be forged. Thus, improved techniques for verifying identity and personal data are required.

### BRIEF SUMMARY

One aspect of the present disclosure relates to a method for computing an application score. The method includes receiving, by a computer system, an application object for an application. In some embodiments, the application object includes application data associated with a first borrower. The method includes extracting information from the application, capturing features from pooled data across time and lenders, ingesting the captured features into a Recurrent Neural Network (“RNN”), generating a preliminary risk score with the RNN based on the ingested captured features, scaling the preliminary risk score to a range of application scores to determine the application score for the application, determining one or more reason codes for the application based at least in part on the application score for the application, and providing the application score and the one or more reason codes to a dealer user device or a lender user device.

In some embodiments, the RNN can be a Long Short-Term Memory (LSTM) model. In some embodiments, the LSTM model can be a forward-only LSTM model processing applications in order from least recent to most recent. In some embodiments, the LSTM model can include at least 5 layers. In some embodiments, the LSTM model can be an LSTM layer having 128 nodes. In some embodiments, the RNN can be a deep learning Neural Network.

In some embodiments, the method includes receiving the pooled data. In some embodiments, the method includes matching data for common individuals across time and across multiple lenders in the pooled data. In some embodiments, matching data for common individuals across time and across multiple lenders in the pooled data is performed by a second machine learning model. In some embodiments, matching data for common individuals across time and across multiple lenders in the pooled data utilizes multiple alternative matching criteria thereby creating inexact matches between one or more data elements.

In some embodiments, capturing features from pooled data across time and lenders can include generating a vector for each previous application identified for the first borrower in the pooled data. In some embodiments, the vectors for the first borrower are arranged in a matrix. In some embodiments, the matrix can include up to a maximum number of vectors. In some embodiments, vectors associated with the first borrower and meeting selection criteria are added to the matrix.

In some embodiments, ingesting the captured features into a RNN can include ingesting the vectors one-at-a-time into the RNN. In some embodiments, the vectors are ingested into the RNN in a reverse sequence. In some embodiments, the vector can include a feature characterizing a time between the present application and between each previous application. In some embodiments, the vector includes at least one feature that is not future-oriented.

### BRIEF DESCRIPTION OF THE DRAWINGS

FIG. 1 illustrates a distributed computing system for fraud detection according to an embodiment of the present disclosure.

FIG. 2 illustrates a fraud detection system according to an embodiment of the present disclosure.

FIG. 3 illustrates another example of the fraud detection system according to an embodiment of the present disclosure.

FIG. 4 is a flowchart illustrating one embodiment of a process for automated risk scoring.

FIGS. 5A, 5B and 5C together illustrate a report for indicating a score according to an embodiment of the disclosure.

FIG. 6 a distributed computing system for fraud detection according to an embodiment of the present disclosure.

FIG. 7 illustrates an example of a computer system that may be used to implement certain embodiments of the present disclosure.

### DETAILED DESCRIPTION

In the following description, various embodiments will be described. It should be apparent to one skilled in the art that embodiments may be practiced without specific details, which may have been admitted or simplified in order to not obscure the embodiment described.

Illustrative examples are given to introduce the reader to the general subject matter discussed herein and are not intended to limit the scope of the disclosed concepts. The following sections describe various additional features and examples with reference to the drawings in which like numerals indicate like elements, and directional descriptions are used to describe the illustrative aspects, but, like the illustrative aspects, should not be used to limit the present disclosure.

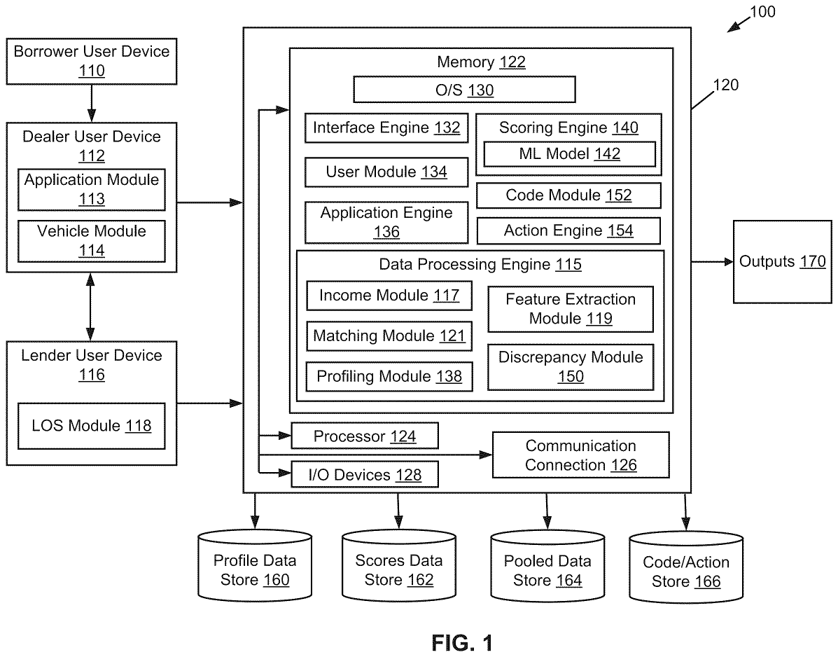

FIG. 1 illustrates a distributed computing system 100 for fraud detection according to an embodiment of the present disclosure. As illustrated, the distributed computing system 100 includes a borrower user device 110, a dealer user device 112, a lender user device 116, and a fraud detection computer system 120. In some examples, devices illustrated herein may comprise a mixture of physical and cloud computing components. Each of these devices may transmit electronic messages via a communication network. Names of these and other computing devices are provided for illustrative purposes and should not limit implementations of the disclosure.

The borrower user device 110, the dealer user device 112, and the lender user device 116 may display content received from one or more other computer systems, and may support various types of user interactions with the content. These devices may include mobile or non-mobile devices such as smartphones, tablet computers, personal digital assistants, and wearable computing devices. Such devices may run a variety of operating systems and may be enabled for Internet, e-mail, short message service (SMS), Bluetooth®, mobile radio-frequency identification (M-RFID), and/or other communication protocols. These devices may be general purpose personal computers or special-purpose computing devices including, by way of example, personal computers, laptop computers, workstation computers, projection devices, and interactive room display systems. Additionally, the borrower user device 110, the dealer user device 112, and the lender user device 116 may be any other electronic devices, such as a thin-client computers, Internet-enabled gaming systems, business or home appliances, and/or personal messaging devices, capable of communicating over network(s).

In different contexts, the borrower user device 110, the dealer user device 112, and the lender user device 116 may correspond to different types of specialized devices. In some embodiments, one or more of these devices may operate in the same physical location, such as a finance center or other location that manages or restricts access to items or services. In such cases, the devices may contain components that support direct communications with other nearby devices, such as wireless transceivers and wireless communication interfaces, Ethernet sockets or other Local Area Network (LAN) interfaces, etc. In other implementations, these devices need not be used at the same location but may be used in remote geographic locations in which each device may use security features and/or specialized hardware (e.g., hardware-accelerated SSL and HTTPS, WS-Security, firewalls, etc.) to communicate with the fraud detection computer system 120 and/or other remotely located user devices.

The borrower user device 110, the dealer user device 112, and the lender user device 116 may each include at least one memory and one or more processing units that may be implemented as hardware, computer executable instructions, firmware, or combinations thereof. The computer executable instruction or firmware implementations of the processor may include machine executable instructions written in any suitable programming language to perform the various functions described herein. These user devices may also include geolocation devices communicating with a global positioning system (GPS) device for providing or recording geographic location information associated with the user devices.

The memory may store program instructions that are loadable and executable on processors of the user devices, as well as data generated during execution of these programs. Depending on the configuration and type of user device, the memory may be volatile (e.g., random access memory (RAM), etc.) and/or non-volatile (e.g., read-only memory (ROM), flash memory, etc.). The user devices may also include additional removable storage and/or non-removable storage including, but not limited to, magnetic storage, optical disks, and/or tape storage. The disk drives and their associated computer-readable media may provide non-volatile storage of computer-readable instructions, data structures, program modules, and other data for the computing devices. In some implementations, the memory may include multiple different types of memory, such as static random access memory (SRAM), dynamic random access memory (DRAM), or ROM.

The borrower user device 110, the dealer user device 112, the lender user device 116, and the fraud detection computer system 120 may communicate via one or more networks, including private or public networks. Some examples of networks may include cable networks, the Internet, wireless networks, cellular networks, and the like.

In some examples, the borrower user device 110 may provide application data to the dealer user device 112, the lender user device 116, or a combination thereof for a variety of purposes. The application data may be associated with one or more borrower users. A borrower user can be an individual or an entity (e.g., a business or organization) that may submit application data in a loan application or other suitable application type with the goal of receiving access to or funds for an item or service and/or funds for a personal loan. The application data may include identity and contact data such as Social Security Number, first and last name, date of birth, home address, personal phone numbers such as home, work, and mobile phone numbers; income and employment data including employer name and phone number, borrower occupation, duration of employment, and annual income; credit information such as time on file, number of trade lines, inquiries, high credit amounts, automobile or mortgage trade line information, authorized trade line information, status of current trade lines, prior delinquencies, defaults, and/or charge-offs; collateral information such as a vehicle make, model, year, Vehicle Information Number (VIN), and sale price; loan structure information such as type and amount of down payment, trade-in, loan amount, loan term in months, payment-to-income ratios, debt-to-income ratios; and other information about the applicant(s) that might be used by a lender in making decisions about whether to approve a loan and/or how much credit to extend and at what rates and terms.

Upon receiving the application data, the dealer user device 112, or the lender user device 116 may approve or restrict the access to or funds for the item or service. For example, a loan, lease, or purchase of the item or service may be approved, denied, or approved conditionally, subject to one or more stipulations.

Furthermore, the dealer user device 112 may correspond with a dealer user. The dealer user can be an individual or entity which sells or distributes the item or service (e.g., a vehicle). The dealer user device 112 can transmit and receive application data or other suitable data to and from the borrower user device 110, the lender user device 116, the fraud detection computing system 120, or a combination thereof. For example, a borrower user may submit application data, via the borrower user device 110, in a request for a loan to purchase a vehicle. The dealer user device 112 may receive the application data associated with the request and may transmit the application data, including vehicle data (e.g., make, model, year of manufacture, vehicle identification number (VIN), and price) to the lender user device 116.

The dealer user device 112 may include an application module 113. The application module 113 may be configured to receive application data. The application data may be transmitted via a network from the borrower user device 110. Alternatively, in some examples, the application data may be provided directly at the dealer user device 112 via a user interface and without a network transmission. In some embodiments, the application module may be part of, or integrated with a Dealer Management System (DMS) and/or a Finance and Insurance tool, which can be commercial or in-house-built.

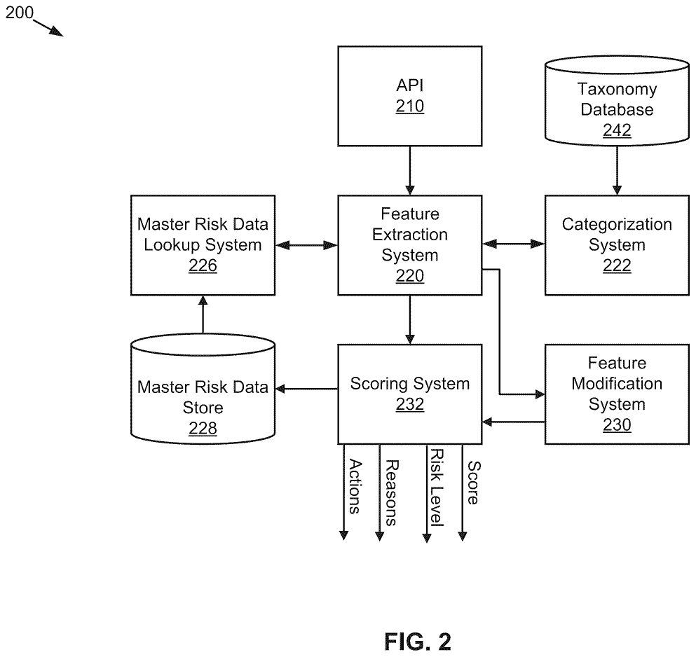

The application module 113 may provide a template to receive particular application data corresponding with characteristics (e.g., location, income, date of birth, etc.) of a borrower user. The application module 113 may also be configured to transmit application data to the fraud detection computer system 120. The application data may be encoded in an electronic message and transmitted via a network to an application programming interface (API) associated with the fraud detection computer system 120. Additional details regarding the transmission of this data are provided below with FIG. 2.

In some examples, the dealer user device 112 can further include a vehicle module 114. The vehicle module 114 may be configured to receive and provide vehicle data. For example, the dealer user may receive vehicle data, including make, model, vehicle identification number (VIN), price, and other relevant information to store in a data store of vehicles. The data store of vehicles may be managed by the dealer user to maintain data indicating an inventory of vehicles available to the dealer user. In some examples, the dealer user may offer the vehicles identified in the data store of vehicles with the vehicle module 114 to the borrower user in exchange for funding provided by the borrower user. The application data may be used, in part, to secure the funding in exchange for the vehicle.

The lender user device 116 may correspond with a lender user. The lender user can be an individual or entity (e.g., a financial institution), which may provide funds to a borrower user under an agreement for repayment. The lender user may perform an assessment of the borrower user's credibility with respect to repayment prior to providing the funds. To do so, the lender user device 116 may transmit or receive application data or other suitable information to and from the dealer user device 112, the borrower user device 110, the fraud detection computing system 120, or a combination thereof.

The fraud detection system 120 can comprise a data processing engine 115. The data processing engine 115 can be located in memory 122 and can comprise code and/or one or several software modules, models, data, or the like.

In some embodiments, the data processing engine 115 can comprise the income module 117. The income module 117 may provide statistical summaries of income data across different user segments, such as statistical summaries associated with location, employer, and occupation. The statistical summaries can further be associated with varying levels of aggregation at each user segment. For example, the income module 117 may provide statistical summaries for a ZIP code as well as a corresponding city and state. The income data from the income module 117 can be used by the fraud detection computer system 120, and specifically can be stored in a profile data store 160, a scores data store 162, or a combination thereof. The income data can be used by the fraud detection computing system 120 in verifying stated incomes.

The lender user device 116 may comprise a LOS module 118. The loan origination system (LOS) module 118 may be configured to generate an application object with application data.

The fraud detection computing system 120, and in some embodiments, the data processing engine 115 can further comprise a feature extraction module 119. The feature extraction module 119 can be configured to identify and/or extract features from data, which data can be, for example, across time and/or across one or several lenders.

The fraud detection computing system 120, and in some embodiments the data processing engine 115 can further comprise a matching module 121. The matching module 121 can be configured to evaluate large data sets to identify matching data. This data set can, in some embodiments, extend across a period of time and/or across one or several lenders. In some embodiments, the matching module 121 can be configured to identify data associated with one or several common individuals across time and/or across multiple lenders.

Specifically, in some embodiments, the matching module 121 can be configured to identify an individual such as a borrower, and identify data contained in a dataset relevant to that individual. This can include, for example, identifying data and/or features of the individual and finding other records associated with some or all of the identifying data and/or features of the individual. In some embodiments, this can include, for example, matching records based on, for example, a borrower name, address, Social Security Number, date of birth, phone number, identification number, and/or the like. In some embodiments, the matching module 121 can utilize multiple alternative matching algorithms which may in turn utilize one or more approximate matching methods (e.g., fuzzy matching) to determine whether the borrower users listed on two or more applications correspond to the same borrower user entity. For example, two borrower users may be considered to match if they have the same Social Security Number. Alternatively, two borrower users may be considered to match if they have identical addresses and only slight spelling variations in their names, even if their Social Security Numbers are significantly different.

Additionally, the borrower user device 110, the dealer user device 112, and the lender user device 116 may comprise one or more software applications for interacting with other computers or devices, including cloud-based software services, via a network (e.g., a LAN or the internet). The software applications may be capable of handling requests from users and information from various webpages. The software applications may further be capable of receiving application data or other information from and transmitting the application data or other information to various devices on the network.

The dealer user device 112, the lender user device 116, or a combination thereof may further perform electronic communications with the fraud detection computer system 120. The fraud detection computer system 120 may correspond with any computing device or server on a distributed network, including processing units 124 that communicate with a number of peripheral subsystems via a bus subsystem. These peripheral subsystems may include memory 122, a communications connection 126, input/output devices 128, or a combination thereof.

The memory 122 of the fraud detection computer system 120 may include instructions that are loadable and executable on processor 124, as well as data generated during the execution of these programs. The memory 122 may be volatile (such as random access memory (RAM)) and/or non-volatile (such as read-only memory (ROM), flash memory, etc.). The fraud detection computer system 120 may also include additional removable storage and/or non-removable storage including, but not limited to, magnetic storage, optical disks, and/or tape storage. The disk drives and their associated computer-readable media may provide non-volatile storage of computer-readable instructions, data structures, program modules, or the like for the fraud detection computer system 120. In some implementations, the memory 122 may include multiple different types of memory, such as solid-state drives (SSD), SRAM, DRAM, or ROM.

The memory 122 is an example of computer readable storage media. For example, computer storage media may include volatile or nonvolatile, removable or non-removable media, implemented in any methodology or technology for storage of information such as computer readable instructions, data structures, program modules, or other data. Additional types of memory computer storage media may include PRAM, SRAM, DRAM, RAM, ROM, EEPROM, flash memory or other memory technology, CD-ROM, DVD or other optical storage, magnetic cassettes, magnetic tape, magnetic disk storage or other magnetic storage devices, or any other medium which can be used to store the desired information and can be accessed by the fraud detection computer system 120. Combinations of any of the above should also be included within the scope of computer-readable media.

The communications connection 126 may allow the fraud detection computer system 120 to communicate with a data store, one or more databases, servers, or other devices on the network. The fraud detection computer system 120 may also include input/output devices 128, such as a keyboard, a mouse, a voice input device, a display, speakers, a printer, and the like.

Reviewing the contents of memory 122 in more detail, the memory 122 may comprise an operating system 130, an interface engine 132, a user module 134, an application engine 136, a profiling module 138, a scoring engine 140, a discrepancy module 150, a fraud scoring engine 152, a code module 154, and/or an action engine 156, or a combination thereof. The fraud detection computer system 120 may receive data from and store data in various data stores, such as the profile data store 160, the scores data store 162, and the pooled data store 164. The modules and engines described herein may be software modules, hardware modules, or a combination thereof. If the modules are software modules, the modules can be embodied in a non-transitory computer readable medium and processed by a processor with computer systems described herein. In some embodiments, the modules can be processed by one or more cloud computing resources, virtual machines, on-premise computing resources, bare-metal machines, via Infrastructure as Code IaC, and/or the like.

The interface engine 132 may be configured to receive application data and/or transmit output (e.g., predictions, error estimates, scores, etc.) to user devices (e.g., the dealer user device 112, or the lender user device 116). In some examples, the interface engine 132 may implement an application programming interface (API) to receive or transmit data.

The user module 134 may be configured to identify one or more users or user devices associated with the fraud detection computer system 120. The user module 134 may further associate each user or user device with a user identifier and a plurality of data. The user identifier and the plurality of data can be stored in the profiles data store 160.

Similar to the interface engine, the application engine 136 may be configured to receive application data from the dealer user device 112, the lender user device 116, or a combination thereof via a network communication message, API transmission, or the like. The application engine 136 may filter or limit the application data received from the dealer user device 112 or the lender user device 116. The application engine 136 may further store historical application data, including fraud scores, income scores, and/or other scores determined by the fraud detection computing system 120 for previous applications.

The application engine 136 may be configured to associate a time with receiving the application data. For example, a plurality of applications may be received from a first lender user device associated with a borrower user within a predetermined time range (e.g., under one minute). The application engine 136 may be configured to identify the plurality of applications from a source (e.g., the lender or dealer user device) or to a destination (e.g., the lender user device) within the time range. In some examples, the application engine 136 may also be configured to identify an item above a price range identified with application data in addition to the time information. These features of the application may help identify an increased likelihood of fraud (e.g., fifteen applications for expensive cars within five minutes may identify a fraud ring, etc.).

The application engine 136 may also be configured to store historical application data and any corresponding risk metrics or indicators occurring in association with the application. For example, an application may be submitted and approved by the lender user device, and the lender user device may provide funds in response to approving the application for a borrower user. The indication of approval as well as the application data and/or an originating dealer user of the application may be stored in the profiles data store 160. Subsequent interactions with the borrower may also be identified, including non-repayment of a loan resulting from fraudulent information in an application (e.g., fraudulent reporting of a salary or employment of the borrower user, identity theft, inclusion of a false borrower (“straw borrower”) on the application who may be unaware and/or not an actual party to the purchase of collateral, false representation of the collateral, down payment, or other application information by the dealer (“powerbooking” or other dealer fraud), use of a false Social Security Number or other identifying information to avoid disclosing accurate credit history (“synthetic identity”), etc.). The profiles data store 160 may identify input features from the application data and correlate the input features with an increased likelihood of fraud.

The application engine 136 can be configured to extract one or several features and/or other pieces of information from the received information. This can include, for example, extracting information identifying the borrower user and/or one or several attributes of the borrower user. This information can further include, for example, information relating to an income of the borrower user. In some embodiments, the application engine 136 can be configured to extract features from the pooled data. In some embodiments, these features can include and/or relate to income, employer, occupation, and/or statistics relating to these. In some embodiments, the features can include and/or relate to, for example, a vehicle identification number (VIN), a make, model, year, price, historical transaction information that can be, for example, associated with the VIN, historical statistical summaries of similar vehicles, or the like. The features can, in some embodiments, include features matching a borrower and/or employer to a negative file of known bad actors, using names, SSNs, phone numbers for matching. The features can, in some embodiments, include features that detect patterns associated with specific types of fraud, such as straw borrower, synthetic identity, power booking, dealer fraud, and true-name identity theft, and/or the like. In some embodiments, the features can include, one or more employer profiles, which can include, for example, a negative file identifying one or several fake employers. In some embodiments, the negative file can identify one or several fake names and/or fake telephone numbers associated with some or all of the fake employers. In some embodiments, the features can include a VIN profile, a dealer profile, a borrower profile, one or more employment taxonomies which can include one or several statistical summaries, and/or the like. In some embodiments, each of some or all of these features can comprise a vector and/or a matrix.

The fraud detection computer system 120, and in some embodiments the data processing engine 115 may comprise a profiling module 138. The profiling module 138 may be configured to determine a profile of a borrower user or a dealer user. The profile may correspond with one or more characteristics of the user, including income, employment, identity, or the like. In some examples, the profiling module 138 may store any instance of fraud associated with the user device in the profile data store 160.

The profiling module 138 may also be configured to determine one or more segments of the user. A segment may be determined from application data and/or by comparing application data with a predetermined threshold associated with each segment. As a sample illustration, one or more segments may include prime, subprime, or nonprime credit or, for example, franchise or independent dealer types. A borrower user may provide application data that includes a credit score greater than 700. The profiling module 138 may be configured to, for example, assign the prime segment to any credit score greater than 700 (e.g., predetermined threshold for credit scores). In this illustration, the profiling module 138 may identify the borrower user as corresponding with the prime segment.

The profiling module 138 may also be configured to receive a request for a second level score from a third lender user device 116 and identify historical data associated with dealer user devices that have interacted with the third lender user device 116. In some examples, the second level score may correspond with a particular dealer user device.

The scoring engine 140 can be configured to generate outputs of the fraud detection computing system 120. The outputs may be transmitted via the interface engine 132 to the dealer user device 112, the lender user device 116, or a combination thereof. In some examples, the outputs may be provided as an electronic notification to a user device.

In some embodiments, the scoring engine 140 can be configured to determine and/or select one or more machine learning (ML) models to apply to application data. In some examples, the discrepancies or similarities between the risk profile and the application data may be provided as input to the ML model as well. Different models may also be used to detect different entities committing the fraud (e.g., borrower fraud v. dealer fraud), or to predict a fraud type (e.g., income fraud, collateral fraud, identity fraud, straw borrower fraud, employment fraud, etc.). These different models may be constructed using an input feature library where one or more input features may be based on a variety of micro fraud patterns observed in the application data.

The ML model can be trained. For example, the ML model can be trained using historical application data by receiving a plurality of application data and determinations of whether fraud was discovered according to the risk profiles described herein. Signals of fraud that can be common across the historical application data can be used to identify fraud in subsequent application data prior to the fraud occurring.

To generate the outputs, the scoring engine 140 can include a ML model 142. The ML model 142, also referred to herein as the first ML model 142 can comprise a Recurrent Neural Network (“RNN”), and specifically, can comprise a Long Short-Term Memory (LSTM) model. An LSTM model can be a specialized type of RNN that can process and learn from sequential data while addressing the vanishing gradient problem commonly faced by traditional RNNs. The LSTM can be effective in tasks requiring the recognition of patterns and dependencies over long sequences, such as over a period of time, as the LSTM can selectively retain and forget information through its unique gating mechanisms—input, output, and forget gates. These gates enable the LSTM to determine which information to store, update, or discard, making them ideal for applications like natural language processing, speech recognition, and time-series analysis.

In some embodiments, the LSTM can comprise a plurality of layers, and specifically can comprise five layers including three hidden layers and two exposed layers. In some embodiments, the LSTM can include at least one LSTM layer, which LSTM layer can include, in some embodiments, 128 nodes, between 100 nodes and 150 nodes, or any other or intermediate number of nodes. In some embodiments, the LSTM can be a forward-only LSTM, a forward-backward LSTM, and/or a bi-directional LSTM. In some embodiments, and as used herein, “forward” refers to processing applications in order from least recent to most recent, with the most recent application being the application presently received.

In some embodiments, the LSTM can utilize a sigmoid activation function for prediction nodes, and a Rectified Linear Unit (ReLU) activation function for other nodes. In some embodiments, the LSTM can be trained utilizing a 25% dropout rate, enabling the model to perform robustly in the face of one or more noisy inputs.

In some embodiments, the ML model 142 can be a deep learning model that can be configured to ingest features, such as the features captured and/or extracted from the pooled data, and output data indicative of a lending risk associated with the borrower. In some embodiments, this can include the generation of a risk score, which can be, for example, a preliminary risk score.

The ML model 142 may also correlate the input features from application data with an increased application score for future applications that match input features of the fraudulent borrower user. For subsequent applications that are received by the fraud detection computer system 120, the greater application score corresponding with a higher likelihood of fraud may correspond with this historical application data and identified non-repayment of the loan originating from the fraudulent application data (e.g., stored and matched with the profiles data store 160).

The ML model 142 may be configured to apply or adjust a weight to historical application data or other input features. For example, application data associated with applications that occur within a predetermined time range may be weighted higher than application data that occurs outside of the predetermined time range. As a sample illustration, application data used to determine a second level score for a dealer user device may weight input features of applications associated with fraud within the past year as having a greater effect on the second level score than applications associated with fraud that occurred greater than a year from a current date. In this example, a dealer user device may correspond with a higher likelihood of fraud when fraudulent applications are submitted to a lender user device more recently than when the fraudulent applications were submitted historically (e.g., greater than a predetermined time range).

The ML model 142 may be configured to apply or adjust a weight to input features associated with a segment. The weights may be adjusted while training of the ML model. In some examples, the weights may be adjusted to correspond with a risk profile of a borrower user, dealer user, or lender user.

The fraud detection computer system 120, and in some embodiments a data processing engine 150 may comprise a discrepancy module 150. The discrepancy module 150 may be configured to determine differences and discrepancies between information provided with the application as application data and threshold values associated with a standard user profile (e.g., from a third-party data source, from consortium data, etc.). For example, a first standard user profile may correspond with a combination of a particular career in a particular location may correspond with a particular salary range. When the application data asserts a different salary that falls outside of the salary range, the discrepancy module 150 may be configured to identify that discrepancy between the provided data and the expected data associated with the first standard user profile. In some examples, each discrepancy may adjust the application score for an increased likelihood of fraud (e.g., increase the score to a greater score than an application without the discrepancy, etc.).

The discrepancy module 150 may also be configured to identify one or more risk indicators. For example, the discrepancy module 150 may review the application data and compare a subset of the application data with one or more risk profiles. When the similarities between the application data and the risk profile exceed a risk threshold, the discrepancy module 150 may be configured to identify an increased likelihood of fraud or risk with the application.

The discrepancy module 150 may also be configured to determine a risk profile. In some examples, the discrepancy module 150 may be configured to compare the risk profile with the application data to determine similarities or discrepancies between the risk profile and the application data. Weights may be adjusted in the context of other input features presented according to the risk profile (e.g., during training of the ML model, etc.). Potential risk profiles may include a straw borrower, income fraud, collateral fraud, employment fraud, synthetic identity, early payment default, misrepresentation without loss, dealer fraud, or geography fraud. Other types of risk profiles are available without diverting from the essence of the disclosure.

An example risk profile may comprise a straw borrower. For example, a borrower user may provide application data corresponding with their true identity and the vehicle corresponding with the application data may be driven and maintained by a different user. Another example of a straw borrower can include a borrower providing their true identify and providing a co-borrower who will not be the user of the vehicle or of the purchased item, will not be paying back the loan, and/or may not be aware that they are being identified as a co-borrower. The borrower user may fraudulently assert that the vehicle is for their use. The borrower user, in some examples, may be offered different interest rates or different requirements for taking possession of the vehicle. For example, the user who is driving and maintaining the vehicle may not otherwise meet the credit requirements or other requirements necessary to be eligible to purchase the vehicle. The differences associated with offers provided by the lender user to the borrower user may incentivize the borrower user to provide fraudulent application data to receive better offers.

In some examples, one or more signals of a straw borrower may be provided in the application data. For example, the application data may comprise different addresses between borrower and co-borrower (e.g., by determining a physical location of each address and comparing the distance between the two addresses to a distance threshold). In another example, the application data may comprise different ages between borrower and co-borrower (e.g., by determining an age of each borrower entity from a date of birth and comparing the difference in ages to an age threshold). In yet another example, the application data may be compared with a user profile corresponding with a particular vehicle (e.g., by receiving a user profile of a borrower that typically owns the vehicle and comparing at least a portion of the profile with application data associated with the borrower user applying for the current vehicle, including ages of the standard user and the current user).

Another example risk profile may comprise income fraud. For example, a borrower user may provide application data corresponding with their true employment data, including employer and job title, yet salary provided with the application data may be inaccurate. The borrower user may fraudulently state their income for various reasons, including to qualify for a greater value of a loan from a lender user or to receive a better interest rate. The discrepancy module 150 may be configured to match the employment data with known salary ranges for a particular employer or job title in a particular geographic location. Any discrepancy between known salary ranges and the asserted salary with the application data may result in the generation of features that can increase the application score that identifies the likelihood of fraud or risk with application.

Another example risk profile may comprise a collateral fraud. For example, a borrower user may provide accurate information for an application and a dealer user may provide fraudulent information for the same application, with or without the knowledge of the borrower user. As a sample illustration, the dealer user may understate mileage for a used vehicle or represent the condition of the vehicle to be better than it actually is, in order to help the borrower qualify for a loan from the lender user that would otherwise not be approved. In some examples, the dealer user may intentionally inflate the value of the vehicle by misrepresenting the features on the car to the lender user. In some examples, the lender user may rely on the fraudulent application data to calculate a “Loan To Value” ratio, so that the actual value of the vehicle may be less than the calculated value of the vehicle.

Another example risk profile may comprise employment fraud. For example, a borrower user may provide application data corresponding with employment that is inaccurate, including an incorrect employer, contact information, or job title. In some examples, the borrower user may be unemployed and may identify a nonexistent employer in the application data. The discrepancy module 150 may be configured to compare the name of the employer with historical application data to identify any new employers that have not been previously identified in previous applications. In some examples, the employer data from the application data may be compared with third-party data sources (e.g., distributed data store, website crawl, etc.) to accumulate additional employer data and store with the profile data store 160. The discrepancy in comparing the name of the employer with employer data may increase application score that identifies the likelihood of fraud or risk with the application.

Another example risk profile may comprise a synthetic identity. For example, a borrower user may provide application data corresponding with their true identity and may access a unique user identifier (e.g., Social Security number, universal identifier, etc.) that does not correspond with their true identity. The borrower user may provide the fraudulent user identifier, such as an unused identifier or the identifier of another person with their application data and assert the fraudulent user identifier as their own. The discrepancy module 150 may be configured to access user data corresponding with the unique user identifier from a third party source and compare the user data with application data provided by the borrower user. Any discrepancies between the two sources of data may be used to generate features that can affect the application score, and in instances in which these features increase the application score, the increased application score can identify an increased likelihood of fraud.

Another example risk profile may comprise an early payment default. For example, a borrower user may be likely to default within a predetermined amount of time (e.g., six months) of a loan funding from the lender user device. The discrepancy module 150 may be configured to compare historical application data with the current application data to identify one or more input features in the application data that match historical applications that have defaulted within the predetermined amount of time of the loan funding. Any similarities between the two sources of data may be used to update the application score to identify an increased likelihood of fraud.

Another example risk profile may comprise misrepresentation without loss. For example, a borrower user may not be likely to default within the predetermined amount of time of a loan funding from the lender user device, but the borrower user may have provided fraudulent data with the application originally. The discrepancy module 150 may be configured to identify the fraud and update the application score to identify a lower likelihood of risk to a lender user device.

Another example risk profile may comprise dealer fraud. For example, a dealer user may accept a plurality of applications from a plurality of borrower users. The dealer user may add fraudulent information to the applications rather than the borrower user (e.g., to increase the likelihood of approval of a loan from a lender user). In some examples, this type of fraud may affect a second level score (e.g., a dealer user application score) more than a first level score (e.g., a borrower user application score). The discrepancy module 150 may be configured to identify a higher rate of fraud across the plurality of applications that originate from the dealer user and update the application score to identify a higher likelihood of fraud for applications originating from the dealer user.

Another example risk profile may comprise geography-linked fraud. For example, historical fraud data may identify an increased likelihood of fraud and in particular geographic location (e.g., a ZIP Code, a city, a state, or other geographic indicator). The discrepancy module 150 may be configured to identify a borrower user device as also corresponding with a geographic location (e.g., a home location, a work location, etc.). The discrepancy module 150 may be configured to match the geographic locations corresponding with the borrower user device and the location of the increased likelihood of fraud, and adjust a score to identify the increased likelihood of geography fraud for a borrower user associated with that geography (e.g., increase application score from 500 to 550).

The fraud detection computer system 120 can comprise a code module 152. The code module 152 can be configured to determine one or more reason codes for the application. For example, one or more features can influence the application score above a particular threshold to identify a potential risk or fraud. The features can correspond with a reason code that indicates an amount the feature can affect the application score and/or a reason that the feature affects the application score the way that it does. In some examples, the potential reason can be user defined (e.g., an administrator of the service can define reasons for particular features when seen in isolation or in combination with other features). In some examples, the one or more features can be grouped into categories (sometimes referred to as factor groups). Examples of factor groups include income, employment, identity, or the like. In each factor group, one or more features can be identified in order to be used to determine reason codes.

The code module 152 can also be configured to generate a reason code based on the input features that appear to be most prominent on the application score. For example, an income discrepancy can be a first type of feature, and a dealer risk could be a second type of feature. In some examples, the input features can correspond with a plurality of applications and/or aggregated application data associated with a dealer user device. In some examples, an input feature can correspond with a risk signal that can determine a likelihood of fraud associated with a portion of the application data.

The code module 152 can also be configured to provide a generated reason code to a user device. For example, the fraud detection computer system 120 may determine the reason code according to the determined application score and/or information received by a scoring service.

The fraud detection computer system 120 may comprise an action engine 154. The action engine 154 can be configured to determine one or more actions to perform in association with the application score, input features, segment, and other data described herein. The one or more actions may be determined based upon the one or more reason codes or any application data that may influence the application score above the particular threshold (e.g., when a discrepancy is determined between the application data and a third party data source, when a similarity is determined between a risk profile and the application data, etc.). The fraud detection computer system 120, via the ML model, can output the application score along with the one or more reason codes with an indication associated with each of the one or more actions.

The action engine 154 can also be configured to determine a risk based on threshold. For example, when an application is determined to be high risk based upon a risk score.

As a sample illustration, a high application score can correspond with a score of 700 or greater. Accordingly, any application with a score above the threshold of 700, for example, can be determined to be high risk, such that an application corresponding with this score may be, for example, 70% more likely to contain fraudulent information than an application corresponding with a lower score. In another example, one out of twenty applications might be fraudulent, in comparison with one out of one hundred applications that may be fraudulent with a lower score. For another example, when the application is determined to be medium risk, an action of additional review of one or more portions of the application with underwriter review can be suggested. A medium threshold associated with medium risk can correspond with the score range of 300-700. Accordingly, any application with a score within the medium threshold can be determined to be medium risk. For another example, when the application is determined to be low risk, an action of streamlining the application (without additional review) may be suggested. A low threshold associated with low risk can correspond with score range of 1-399. Accordingly, any application with a score between 1-399 can be determined to be low risk.

The action engine 154 can also be configured to suggest actions between the lender user device, dealer user device, and/or the borrower user device. For example, when an application has a high fraud score in comparison with the threshold, an action may be suggested. For another example, when a stated income for a borrower is substantially higher than expected, a borrower user can be asked to provide proof of income. For another example, when a stated employer is associated with a higher risk of fraud based upon prior fraud reports, a lender can be asked to contact the identified employer. For another example, when a borrower, application, and/or bureau profile pattern closely matches prior patterns of synthetic identity fraud, an action to perform an identification check can be suggested.

The action engine 154 and/or code module 152 can also be configured to interact with the code/action data store 166. The code/action data store 166 may include a plurality of reason codes for the application based on the identified application score for the application, as well as a plurality of suggested actions based on the identified application score. In some examples, the action engine 154 and/or code module 152 may provide the application score and any input features associated with the application as search terms to the code/action data store 166. The code/action data store 166 may return one or more reason code descriptions or actions to include with the output.

The fraud detection computer system 120 may be configured to provide various outputs 170 to a user interface. These outputs can include one or several scores, codes, and/or the like. In some embodiments, the one or several scores, codes, and/or the like may be based at least in part on information included in the application. Such information may be received from the borrower user device (e.g., in response to the borrower user submitting the application or the borrower user sending the information separately), the dealer user device (e.g., in response to the dealer submitting the application or the dealer sending the information separately), or the lender user device (e.g., in response to the lender submitting the application or the lender sending the information separately). The application score may be sent to the lender user for the lender user to determine a level of diligence required to assess the application.

In some examples, scores in the output 170 can be compared with one or more score ranges. A first range for application scores may correspond with providing the application score as output to a user device and a second range for application scores may correspond with not providing the application score as output to a user device.

As a sample illustration, a score of three hundred may correspond with a second range for scores that identify applications with a lower likelihood of fraud or risk. When the score is determined in this second range, the fraud detection computer system 120 may identify that fraud is less likely with this application. As another illustration, a score of nine hundred may correspond with a first range of scores that identify applications with a higher likelihood of risk or fraud. When the score is determined in this first range, the fraud detection computer system 120 may provide the score and one or more reason codes for the application corresponding with this higher risk, and one or more actions for the application to help mitigate the risk and reduce the instance of fraud.

In some embodiments, the output may be adjusted based at least in part on the origin of the request. For example, a borrower user may submit an application for an item offered by a dealer user device. The application may request, for example, loan assistance from a first lender user device and/or a second lender user device. The fraud detection computer system 120 may determine a score for the application based at least in part on the historical interactions between the first lender user device and the dealer user device as well as interactions between the second lender user device and the dealer user device As such, one of the input features that are provided to the ML model associated with the application may include an identification of the dealer user device and/or the lender user device.

In another example, the output may be adjusted based at least in part on the entities associated with application. For example, application data associated with a borrower user device may identify a higher likelihood of fraud using any of the methods described herein. The application score may be adjusted higher corresponding with this identified likelihood of fraud associated with the borrower user device. In another example, a dealer user device may be associated with a higher likelihood of fraud across a plurality of applications (e.g., as identified from historical or pooled data, from currently pending application data, etc.). The application score may be adjusted higher for any application corresponding with this identified likelihood of fraud associated with the dealer user device.

In some embodiments, for example, a borrower user can provide information to a borrower user device 110. This information can include an application, which can be an application for a loan. The information can be provided by the borrower user device 110 to fraud detection system 120 via the dealer user device 112 or the lender user device 116. The fraud detection system 120, and specifically the application engine 136 can receive the information and can extract features and/or information portions from the received information.

In some embodiments, and before the receipt of information from the borrower user, data can be pooled, which data can comprise data aggregated over time. This data can include information relating to borrowers, lenders, dealers, and/or the like. In some embodiments, this information can include loan applications submitted by one or more borrowers over a period of time. The fraud detection system 120 can analyze the pooled data to identify data relevant to a common borrower, lender, dealer, and/or the like. Thus, in some embodiments, data can be matched, which data relates to a common borrower, lender, dealer, and/or the like. In some embodiments, this identification of common data can be performed by the matching module 120. Matched information can be stored along with the pooled data in the pooled data store 164. In some embodiments, this can include identifying matching data such as, for example, a matching name, a matching address, a matching social security number, and matching identifier, and/or the like.

In some embodiments, features can be extracted from the pooled data. These features can be extracted, in some embodiments, from the matched data within the pooled data. In some embodiments, these features can be extracted by, for example, the application engine 136. These features can be stored in the pooled data store 164. In some embodiments, the extracted features can be evaluated to identify if some or all of the extracted features should be excluded.

Based on information extracted from the application, features from the pooled data and relevant to the application can be captured. This can include information relevant to the borrower, information relevant to the lender, and/or information relevant to the dealer. In some embodiments, such features can be captured from the pooled data relevant to the borrower and across time and/or across multiple lenders and/or dealers. In some embodiments, this can include aggregating information for the borrower and relating to one or several past applications submitted by the borrower. In some embodiments, limits can be placed on the previous applications, this can include, for example, a maximum number of application such as, for example, a maximum of eight application, a time limit on a maximum age of the applications such as, for example, only applications submitted in, for example, the past ten years, or the like.

Captured features can be utilized by, for example, the ML model 142 to identify patterns across customers and lenders and over time for particular customers (borrowers). In some embodiments, this can include ingesting the captured features in addition to one or several other features into the ML model 142, which ML model 142 can generate a score, which score can characterize a risk associated with the application. The score can then be scaled and/or modified, and can then be provided.

FIG. 2 illustrates a fraud detection system 200 according to an embodiment of the present disclosure. The fraud detection system 200 can be a distributed computing system and may correspond to the fraud detection computer system 120 of FIG. 1. The fraud detection system 200 may be implemented to detect fraud with respect to an application, such as a loan application.

The fraud detection system 200 may include application programming interface (API) 210. The API 210 may be used by devices to communicate with the fraud detection system 200. For example, API 210 may correspond to a website that allows devices to submit a loan application. In other examples, the API 210 may correspond to a receiver that is configured to receive a batch of one or more loan applications. Additionally, in some examples, the API 210 may allow a remote service (e.g., a web service) that is executing on the devices to communicate with the fraud detection system 200. The web service may have a direct connection with the fraud detection system 200 such that the devices may submit a loan application without having to navigate to a web page or send loan applications using the receiver.

The fraud detection system 200 may further include a feature extraction system 220 for identifying features from applications. To identify the features, the feature extraction system 220 may identify borrower attributes from an application and calculate various feature values for each borrower attribute. For example, information such as borrower information, dealer information, lender information, and application information may be received using API 210. Then borrower attributes or other suitable attributes can be obtained from the information. The borrower attributes can include a geographic indicator (e.g., based on an employer address or an applicant address included in the application), an age (e.g., based on a date of birth included in the application), an employer, and an occupation. In some embodiments, these features can include and/or relate to income, employer, occupation, and/or statistics relating to these. In some embodiments, the features can include and/or relate to, for example, a vehicle identification number (VIN), a make, model, year, price, historical transaction information that can be, for example, associated with the VIN, historical statistical summaries of similar vehicles, or the like. The features can, in some embodiments, include features matching a borrower and/or employer to a negative file of known bad actors, using names, SSNs, phone numbers for matching. The features can, in some embodiments, include features that detect patterns associated with specific types of fraud, such as straw borrower, synthetic identity, power booking, dealer fraud, and true-name identity theft, and/or the like. In some embodiments, the features can include, one or more employer profiles, which can include, for example, a negative file identifying one or several fake employers. In some embodiments, the negative file can identify one or several fake names and/or fake telephone numbers associated with some or all of the fake employers. In some embodiments, the features can include a VIN profile, a dealer profile, a borrower profile, one or more employment taxonomies which can include one or several statistical summaries, and/or the like. In some embodiments, each of some or all of these features can comprise a vector and/or a matrix.

Additionally, or alternatively, the feature extraction system 220 may identify taxonomy values for each of the borrower attributes, which may differ in scope. For example, taxonomy values for age may include a year (e.g., 35) and a decade (e.g., 30-40) and the taxonomy values for geographic indicator may include a zip code, city, and state. To determine the taxonomy values, the feature extraction system 220 may transmit the borrower attributes to a categorization system 222. The categorization system 222 may have access to a taxonomy database 242, which may include a lookup table that relates various ages, geographic indicators, employers, and occupations to various taxonomy values.

In some embodiments, the identified taxonomy values can correspond to a taxonomy that is less granular than the associated borrower attribute(s). For example, the borrower may input a zip code, which can be used to find a taxonomy value corresponding to the borrower's state. In some embodiments, and specifically with respect to geographic attributes and taxonomies, abstracting to a less granular taxonomy can protect vulnerable people and/or vulnerable classes by abstracting from a smaller geography to a larger geography, which larger geography will contain a more heterogenous sample of people.

In some examples, the lookup table may not include a specific employer or occupation. Thus, to generate taxonomy values for employers and occupations that are not included in the lookup table, a generative artificial intelligence (AI) model (e.g., Chatbot GPT) may be used. For example, the generative AI model can be configured to output a number (e.g., 2, 5, etc.) of employer categories, occupation categories, or a combination thereof with varying scope when provided an employer and occupation. The employer and occupation categories generated by the generative AI model can be stored in taxonomy database 242 by updating the lookup table to relate the employer and the occupation to the respective categories.

Once the borrower attributes and the taxonomy values for the borrower attributes have been identified, the feature extraction system 220 may access verified income data, historical application data, or other suitable data related to the borrower attributes, the taxonomy values, or a combination thereof. The historical application data can be information which was received through API 210 or previous outputs of an income scoring system 232. For example, the historical application data may include stated incomes, demographic data, geographic data, employment data, or other suitable data included in previous applications. The historical application data can also include predicted incomes, income scores, or the like output by the income scoring system 232 in association with the previous applications. The verified income data can include income values for various employers, occupations, or individuals which have been verified using, for example, published income data, financial statements, or the like.

The historical application data and verified income data can be received by the feature extraction system from the master risk data lookup system 226. The master risk data lookup system 226 may obtain the historical application data and verified incomes from one or more data stores (e.g., master risk data store 228, profile data store 160, and/or scores data store 162, pooled data store 164). The master risk data lookup system 226 may organize or transmit the data and information by user groups associated with borrower attributes. For example, data related to a particular age group, location, employer, or occupation can be packaged and transmitted to the feature extraction system 220. In some embodiments, the master risk data lookup system 226 can obtain information associated with the borrower and across time and/or lenders.

Thus, the feature extraction system 220 can retrieve data related to the borrower attributes, etc. from the master risk data lookup system 226 and perform various calculations to determine feature values. In some examples, the feature values may be computed by performing a mathematical operation on a piece of information associated with the loan application.

In some embodiments, the feature extraction system 220 can include a discrepancy detection system that can include scorecard models and/or expert rules designed to flag inconsistent and/or out-of-pattern data values within the outputs of feature extraction system 220. One example of this type of data value discrepancy may be a loan amount substantially greater than the list price of the collateral. For another example, if the borrower's stated income exceeds the known average income for the borrower's residential area by a certain percentage, or if discrepancies are identified between past incomes provided by the same borrower on one or more other recent loan applications. Discrepancy detection system may output a result to application scoring system 232, master risk data lookup system 226, and/or categorization system 222.

In some examples, the feature extraction system 220 may transmit each feature value to a feature modification system 230. The feature modification system 230 may modify the feature values in order to obtain better results from the income scoring system 232. For example, feature modification system 230 may normalize, transform, and/or scale the features values, and then output the modified feature values to the income scoring system 232.

At the scoring system 232, features, including the borrower attributes, taxonomy values, and corresponding feature values, can be received and used to generate various outputs. Outputs may include a score (e.g., an application score), a reason code (e.g., information corresponding to one or more features identified for their effect on a score), and/or an action (e.g., an instruction to the lender for the lender to perform that corresponds to one or more features). The application score may be used by a lender for the lender to determine a level of diligence required to assess if there are one or more material representations in the application.

In some examples, and as discussed above with respect to FIG. 1, the scoring service may use an ML model for pattern recognition to compute the application score. The pattern recognition model may receive one or more features as input. The pattern recognition model may be trained based upon historical applications. For example, the historical applications may be those that the pattern recognition model has received in the past.

In some embodiments, scoring system 240 may further include a factor group extraction subsystem. The factor group extraction subsystem may order the one or more features used as input to scoring system 240. For instance, the ordering may be based upon an amount that each feature affected a score. The factor group extraction subsystem may also group the one or more features into one or more groups. Each group may be referred to as a factor group. Each feature in a factor group may be related to a particular characteristic (e.g., a type of fraud such as income fraud, collateral fraud, identity fraud, straw borrower fraud, or employment fraud). One or more features in each factor group may then be output. The output features indicating those that most affected the application may be used to determine reason codes. For examples, each feature may correspond to user-defined information that is referred to as a reason code.

In some examples, a feature (or factor group) identified by the factor group extraction subsystem may be mapped to a predicted type of fraud (e.g., income fraud, subprime income fraud, collateral fraud, identity fraud, straw borrower fraud, employment fraud, etc.). In such examples, the type of fraud may be output with the feature. In some examples, based upon the type of fraud and/or the one or more pieces of information, one or more actions may be suggested to the lender. In some cases, the one or more actions may correspond to a level of diligence required to assess if there are one or more material representations in the loan application.

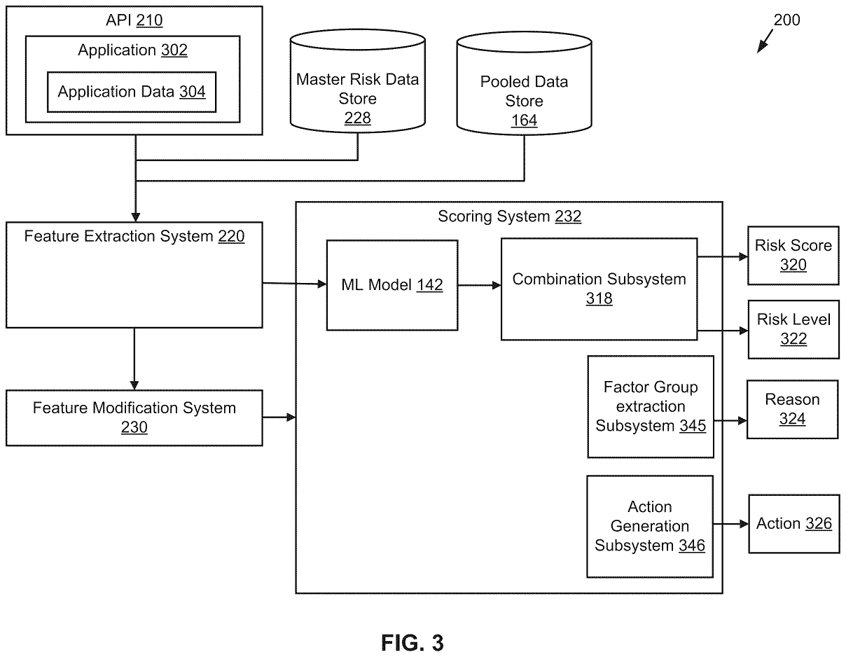

FIG. 3 illustrates another example of the fraud detection system 200 according to an embodiment of the present disclosure. In some examples, the fraud detection system 200 can include an API 210. The API 210 can enable devices within a distributed computing environment, which includes the fraud detection system 200, to communicate. Thus, the API 210 may receive, for example, an application 302 for a loan from a user device, such as dealer user device 112, or lender user device 116 depicted in FIG. 1. In an example, the application 302 can be a loan application submitted by a borrower user via a borrower user device. The loan application can be included in a request for funds for an item (e.g., a vehicle) provided by a dealer user associated with the dealer user device 112. A lender user associated with the lender user device 116 may provide or deny the funds based on the application 302 and information provided by the fraud detection system 200, as described in further detail below. The application 302 can include at least application data 304. The API 210 may further be configured to generate or receive additional application data. For example, the additional application data may include dealer or lender information.

The fraud detection system 200 can further include a feature extraction system 220, which can receive the application data 304 from the API 210 and identify borrower attributes 307. The borrower attributes 307 can be based on the application data 304. For example, the application data 304 may include information usable to identify one or more characteristics of the borrower user, such as name, address, income, employment information, credit score, or the like. As a result, the borrower attributes 307 can include an employer, an occupation, an age, and a geographic indicator (e.g., an address or zip code) for the borrower.

The feature extraction system 220 can further extract features from the master risk data store 228 and/or from the pooled data store 164. In some embodiments, and based on information extracted by the feature extraction system 220, one or several features can be generated and/or calculated. At the scoring system 232, the features can be ingested into the ML model 142. Features can be captured across time and/or lenders for the applicant. This can include identifying one or several previous applications submitted by the borrower. In some embodiments, features can be captured by the feature extraction system 220. Subsequent to the execution of the ML model 142, the scoring system 232 may, in some examples, generate an output. For example, the scoring system 232 may further include combination subsystem 318 for combining outputs from the various models to generate the output. The output can include the income risk score 320 and a risk level 322. The risk level 322 can correspond to the income risk score 320. For example, the risk level 326 can be low, moderate, or high based on the income risk score 320. The output may be received at the dealer user device 112 or the lender user device 116. For example, the income risk score 320 may be sent to the lender user device 116 to enable the lender user to determine whether or not to grant the loan associated with the application 302.

Factor group extraction subsystem 345 may order features received from feature modification system 220 and/or discrepancy detection system. The ordering may be an order of how much the features affected the application score. In some examples, the ordering may be determined using a sensitivity analysis. For example, the factor group extraction subsystem 345 may remove one or more features to determine how much removal of the one or more features affect the application score. The features that change the application score more than other features may be ordered higher.

In some examples, the features may be separated into one or more groups, referred to as factor groups, such that one or more features of each factor group may be output. When separated into one or more groups, each group may be ordered using the sensitivity analysis described above.

Factor group extraction subsystem 345 may output the one or more features identified by factor group extraction subsystem 345 to a location remote from the application scoring system (to a device associated with a lender) and/or to action generation subsystem 346. In some examples, each of the one or more features may be determined to correspond to a reason code. The reason code may also (or in the alternative) be output to the location or to action generation subsystem 346. A reason code may be a reason that a feature is identified by factor group extraction subsystem 345. For example, a reason code may be an amount of change that the factor caused or a string of text that indicates a mostly like reason that the feature is affecting the application score (as defined by an administrator of factor group extraction subsystem 345).

Action generation subsystem 346 may identify one or more actions based upon one or more features output from factor group extraction subsystem 345, one or more reason codes output from factor group extraction subsystem 345, one or more features output from feature modification system 230, one or more features output from discrepancy detection system, or any combination thereof. Action generation subsystem 346 may output the one or more actions from the application scoring system to a device associated with a lender. The one or more actions may indicate what a lender may perform. The actions may include further steps that may be used to determine whether there are one or more material representations in an application, which may prevent fraud or verify that the borrower is not misrepresenting certain information. In one illustrative example, an action may include a requirement that a potential borrower provide verification of income (such as by providing a pay stub, tax returns, and/or other information).

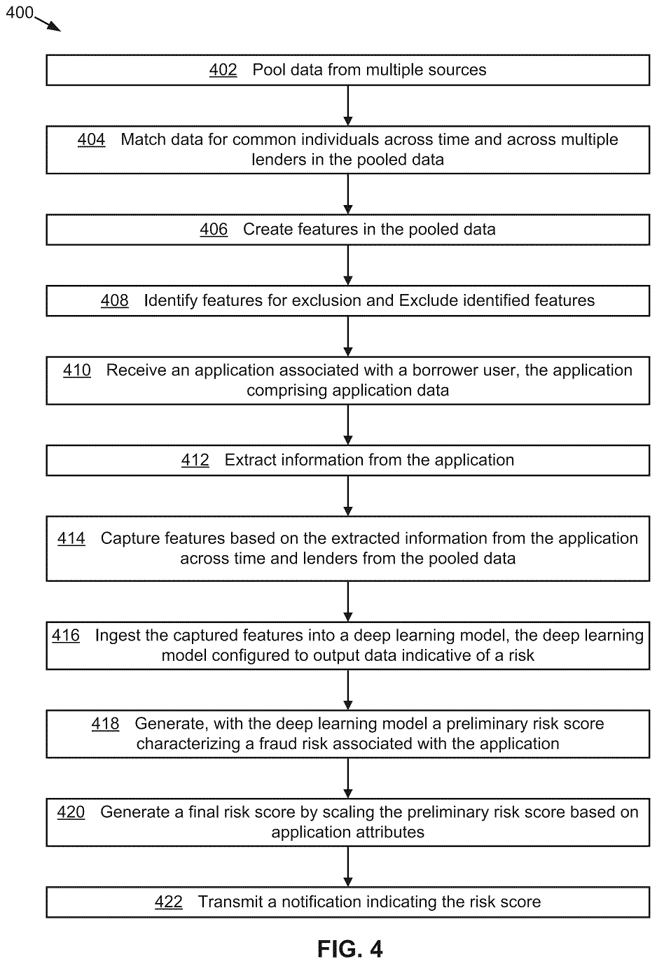

FIG. 4 is a flowchart illustrating one embodiment of a process 400 for risk scoring according to an embodiment of the present disclosure. In some embodiments, the process 400 can be performed by all or portions of the distributed computing system 100 and/or the fraud detection system 200. The process 400 can include more operations, fewer operations, different operations, or a different order of the operations than is shown in FIG. 4. The operations of FIG. 4 are described below with reference to the components of FIGS. 1-3 above.

At block 402, data is pooled. In some embodiments, this data can be pooled from multiple sources. In some embodiments, this data can be pooled from multiple vendors and/or be pooled from multiple sources that include multiple vendors. In some embodiments, this data can be pooled across time and across multiple vendors. This data can include, for example previous applications submitted by one or several borrowers. These applications can be for one or several vendors and/or dealers. In some embodiments, this pooled data can include information relating to the borrowers, relating to the dealers, relating to the lenders, relating to the collateral, and/or the like. In some embodiments, the data can include information identifying the borrower. The information identifying the borrower can include, for example, the borrowers name, social security number, age, address, unique identifier, or the like. In some embodiments, the information can identify one or several attributes of the borrower. These one or several attributes can include, for example, the borrower age, income, address, employer, work sector, credit score, and/or the like. In some embodiments, this information can include a plurality of applications submitted by a borrower, each of which applications can be submitted by a borrower to a lender. In some embodiments, some or all of the loan applications in the pooled data were submitted by a borrower in connection with a dealer such as a car dealer to a lender.

At step 404, data in the pooled data can be matched for common individuals across time and/or across multiple lenders in the pooled data. In some embodiments, data for the common individuals can be matched by the feature extraction system 220. In some embodiments, this can include selecting a piece of data that can identify a borrower and identifying other pooled data including this identifier. This can include, for example, identifying one or several applications in the pooled data that include an identifier found in the present application. Such an identifier can include, for example, a borrower name, address, social security number, identifier, date of birth, phone number, email address, and/or the like.

At step 406, features are created in the pooled data, identified, and/or are extracted from the pooled data. In some embodiments, this can include, for example, identifying and/or extracting information from the pooled data, and calculating and/or generating features from the extracted information.

In some embodiments, the features can include, for example, a negative file identifying one or several bad employers, borrowers, dealers, and/or lenders. The features can include one or several alerts. A list of exemplary alerts, some or all of which may be included in some embodiments, are listed below.

In some embodiments, the features can include, for example, dealer information, dealer profiles, dealer histories, vehicle history, VIN-based vehicle history, social security number death master file hits, income, employment, occupation, known past defaults, known Early Payment Defaults (“EPDs”), or the like. In some embodiments, the features can be created by the feature extraction system 220.

At block 408, features are identified for exclusion and/or are excluded. In some embodiments, these features for exclusion and/or excluded features can include, for example, credit histories associated with EPD, collateral information, loan structure, and/or other non-consumer-behavior related inputs. In some embodiments, features can be identified for exclusion and/or can be excluded by for example, the feature extraction system 220.

At block 410, an application associated with a borrower user can be received. In some embodiments, the application can be received by the interface engine 132 and/or the API 210 from the dealer user device 112. In some embodiments, the application can be received by the interface engine 142 and/or the API 210 from the borrower user device 110 via the dealer user device 112. In some embodiments, the application and be received via the dealer user device 112 and/or the lender user device 116. In some embodiments, the application can include application data. In some embodiments, receiving the application can include receiving, by a computer system, an application object for an application. In some embodiments, the application object includes application data associated with a first borrower user device. In some embodiments, the application is initiated upon receiving a request from the first borrower user device at a second dealer user device or a third lender user device.

At block 412, information is extracted from the application. In some embodiments, this information can be extracted from the application by the feature extraction module 119 and/or the feature extraction system 220. In some embodiments, this feature extraction can include identifying one or several relevant fields of the application and extracting information from those one or several relevant fields. In some embodiments, these features can include a feature characterizing a time between the present application and between each previous application. This feature can be determined based on an application date and/or time stamp associated with each application. Such a forward looking feature, also referred to herein as a future-oriented feature can be unusual as forward looking features can lead to unusual results when using machine learning models to evaluate changing data over time. Applied judiciously however, this feature improves the quality of results when used with the system and/or methods described herein.

At block 414, features are captured from the pooled data based on the information extracted from the application. The features captured from the pooled data can be across time and/or across lenders. In some embodiments, this can include capturing features from information in the pooled data relevant to the borrower. Specifically, this can include capturing features in one or several applications previously submitted by the borrower, which applications can be contained in the pooled data.

In some embodiments, each of the features captured and extracted relating to an application can be organized into a vector. The vectors for a borrower can be aggregated into a matrix. In some embodiments, the size of the matrix can be limited such that only up to a maximum number of vectors can be stored in the matrix. In some embodiments, this maximum number can be, for example, 5 vectors, 6 vectors, 7 vectors, 8 vectors, 9 vectors, 10 vectors, 15 vectors, 20 vectors, between 5 and 15 vectors, between 10 and 20 vectors, between 10 and 50 vectors, and/or any other or intermediate number of vectors. In some embodiments, the matrix and/or the feature extraction system 220 can be configured such that when there are more vectors than can be contained within the matrix, that vectors for adding to the matrix are selected according to one or more selection criteria. In some embodiments, this can include selecting the most recent of the vectors for inclusion in the matrix.

In some embodiments, these selection criteria can further include, for example, criteria for a maximum age of an application associated with a vector. In some embodiments, the maximum age for the applications can prohibit including applications more than 1 year old, more than 5 years old, more than 10 years old, more than 20 years old, between 5 and 15 years old, or more than any other or intermediate number of years.

In some embodiments, the features can be captured from the pooled data via the feature extraction system 220.

At block 416, the captured features are ingested into the ML model 142, which can comprise a deep learning model. In some embodiments, the deep learning model can comprise a deep learning neural network. In some embodiments, the deep learning model can be configured to output a score indicative of a risk such as a lending risk. In some embodiments, the deep learning model can comprise a Recurrent Neural Network (“RNN”). The RNN can, in some embodiments can comprise a Long Short-Term Memory (LSTM) model. The RNN and/or the LSTM can be limited as to the applications that can be identified for a borrower.

In some embodiments, the vectors from the matrix can be ingested one at a time into the ML model 142. These vectors can, in some embodiments be ingested one at a time in a reverse sequence such that the vector characterizing the oldest application is ingested first, followed by the vector characterizing the next oldest application, and so on until all of the vectors have been ingested. The ingestion of these vectors can include the ingestion of the forward-looking feature characterizing the time between each previous application and the present application.

At block 418, the deep learning model, and specifically the RNN and/or the LSTM can output a preliminary risk score. The preliminary risk score characterizes a fraud risk associated with the application. In some embodiments, the LSTM can, by receiving the vectors in a reverse-order sequence, generate a preliminary risk score based on the initial vector, which preliminary risk score can be then modified by each subsequently ingested vector. In some embodiments, the ingestion of each subsequent vector can further result in the generation of a preliminary risk score that is based primarily on the most recently ingested vector, but that is influenced by each previously ingested vector.

In some embodiments, the generation of a preliminary risk score can include determining one or more reason codes and/or one or more actions. In some embodiments, a reason code may indicate information contributing to the application score. In some embodiments, the one or more reasons codes can be generated and/or identified via the Shapley algorithm.

In some examples, the application scores may correspond with reason codes and/or suggested actions to mitigate risk or identify fraud associated with the application data. For example, a first score may correspond with an increased likelihood associated with a first type of fraud. The reason codes associated with this first score may identify this particular first type of fraud in a display of the user interface. The first score may also correspond with suggested actions to mitigate some of the risk, including requesting a second form of authentication or receiving additional data from a third-party entity.

In some embodiments, the one or more actions may be determined based upon the one or more reason codes or any application data that may influence the application score above the particular threshold (e.g., when a discrepancy is determined between the application data and a third party data source, when a similarity is determined between a risk profile and the application data, etc.). The fraud detection computer system 120 may output the application score along with the one or more reason codes with an indication associated with each of the one or more actions.

At block 420, a final risk score is generated. In some embodiments the final risk score can be generated by the combination subsystem 318, which can modify the preliminary risk score up or down based on one or several features, alerts, or the like. In some embodiments, generating the final risk score can further include generating final reason codes and/or actions. At block 422, a notification is transmitted to indicate the final risk score. In some embodiments, this notification can be transmitted to one or both of the dealer user device 112, and the lender user device 116.

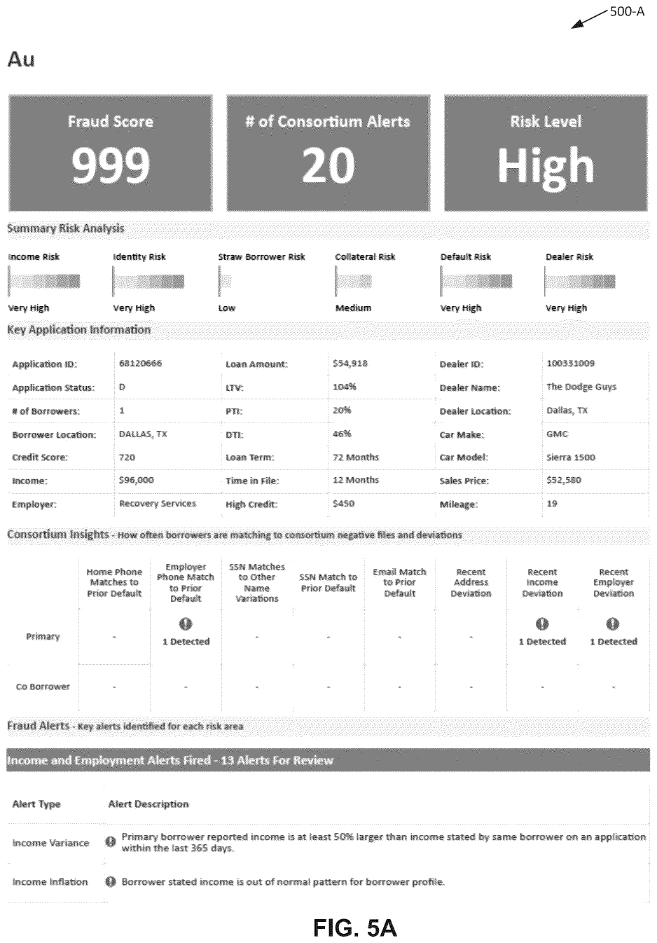

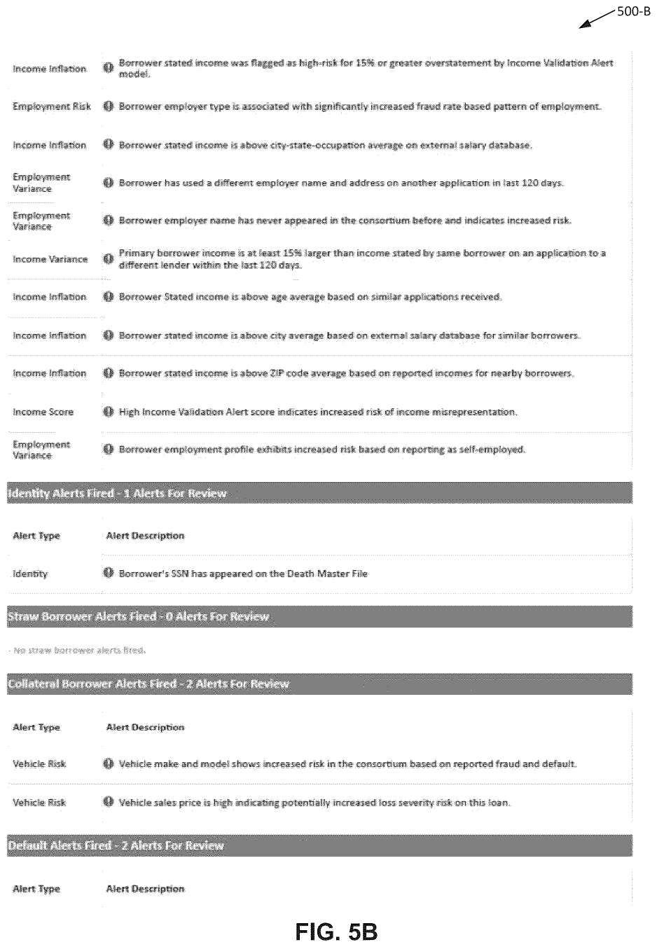

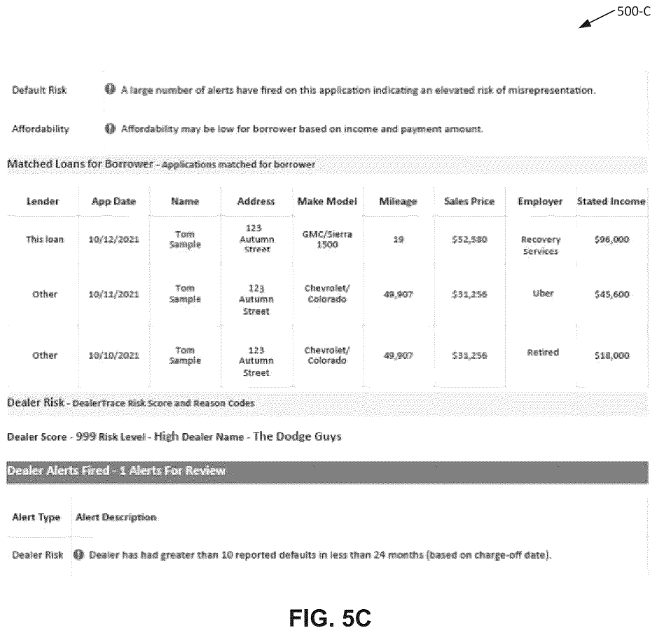

FIGS. 5A, 5B, and 5C together illustrate a report for indicating a score according to an embodiment of the disclosure. FIG. 5A depicts a first page of a report. In illustration 500-A, the report may include a fraud score (also referred to herein as a score or a risk score), an identification of a number of alerts in the report, and an indicator of a risk level. In some embodiments, 500-A further includes a break-down depiction of the fraud score into different sources of fraud risk and characterizes the risk of each of these sources of fraud risk. The sources include an income risk, and identity risk, a straw borrower risk, a collateral risk, a default risk, and/or a dealer risk. The report may comprise aggregated application data and/or application scores by dealer identifier. The report may also comprise dealer information associated with a loan application, including dealer ID, dealer name, location associated with the dealer, a phone number for the dealer, a volume of applications for the domain in a particular amount of time.

In some embodiments, the score (e.g., “999”), which may be calculated as described herein. The risk level (e.g., “high”) may be determined by comparing the second level score to one or more thresholds, each threshold associated with a different level of risk (e.g., high, medium, and low).

The application report further includes alerts, also referred to herein as codes or reasons codes may indicate information associated with a feature that may contribute to the application score. The reason codes may be determined based upon features determined for the dealer that contribute most to the application score. The reason codes may be filtered and provided according to features that cause the application score to increase the greatest amount when compared to other reason codes. For example, a fraud rate may be identified with applications originating from the particular dealer user. When the fraud rate is higher than a threshold value (e.g., a national average, or an average for similar dealer users, etc.), the fraud rate may cause the application score to increase at a greater rate. The reason code associated with the fraud rate may be identified on the application report as well.

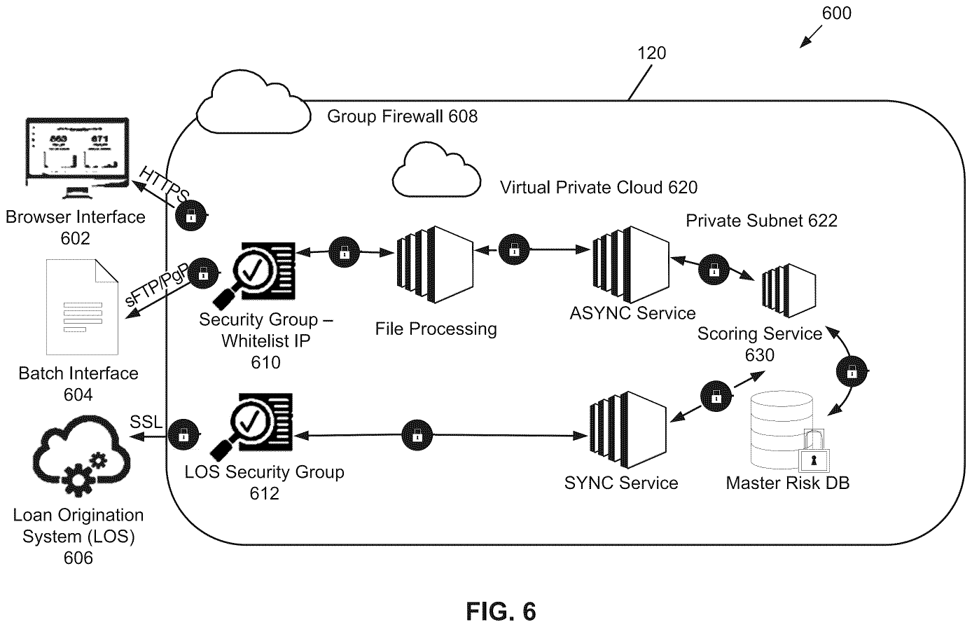

FIG. 6 illustrates another distributed computing system 600 for fraud detection according to an embodiment of the present disclosure. The fraud detection computer system 120 may receive information regarding a loan application using one or more interfaces. For example, the fraud detection computer system 120 may include a browser interface 602, a batch interface 604, and/or a loan origination system (LOS) 606. The browser interface 602 and the loan origination system 606 may be used to submit a loan application to the fraud detection computer system 120. The batch interface 604 may be used to submit multiple loan applications to the fraud detection computer system.

In some examples, browser interface 602 may correspond with a website provided for interfacing with a fraud detection computer system 120. The browser interface 602 may allow for a user (e.g., lender, borrower) to input (e.g., type, drag-and-drop, or provide a file such as XLS, TXT, or CSV) information to the browser interface 602. A borrower may submit their information to a lender. In other examples, the borrower may submit the information to one or more lenders directly. The information may be submitted in a secure manner, such as using HTTPS or SSL. The information may also be encrypted (e.g., PGP encryption).

In some examples, batch interface 604 may allow a user to upload a file (e.g., XLS, TXT, or CSV) to the fraud detection computer system. The file may include information associated with one or more loan applications. In some examples, the batch interface 604 may utilize SFTP to send and receive communications. Scheduled batch interface 604 may also encrypt the file (e.g., PGP encryption).

In some examples, loan origination system 606 may be a service (e.g., a web service) that provides a direct connection with the fraud detection computer system 120 (e.g., synchronous). The loan origination system 606 may operate on a borrower user device, a dealer user device, or a lender user device. The loan origination system 606 may generate an application object for information associated with a loan application, the application object directly used by the fraud detection computer system 120. The loan origination system 606 may then insert information into the application object. The loan origination system 606 may be a service that utilizes HTTP or SSL.

The fraud detection computer system 120 may further include a group firewall 608. The group firewall 608 may include one or more security groups (e.g., security group with whitelist IP list 610 and LOS security group 612). In some examples, the group firewall 208 may be configured to determine whether to allow electronic communications that originate from outside of group firewall 608 to be delivered to a computer system or device inside group firewall 608.

Security group with whitelist IP list 610 may include one or more Internet Protocol (IP) addresses that may be allowed to utilize processes described herein. For example, when a device executing a browser interface attempts to send borrower information, the IP address of the user device may be checked against whitelist IP list 610 to ensure that the user device has permission to utilize services described herein. In one illustrative example, a communication between browser interface and whitelist IP list 610 may be in the form of HTTPS. A similar process may occur when scheduled batch interface sends borrower user information or application data. In one example, an electronic communication between scheduled batch interface 604 and whitelist IP list 610 may be in the form of SFTP or PGP. Comparatively, the LOS security group 612 may manage security regarding the loan origination system 606 in a similar method as the security group with whitelist IP list 610.

Within the group firewall 608, the fraud detection computer system may include a virtual private cloud 620. The virtual private cloud 620 may host one or more services described herein. For example, the virtual private cloud 620 may host a file processing service. The file processing service may decrypt information received from the browser interface 602 or the batch interface 604, generate an application object (as described above), decrypt information that was previously encrypted for electronic communications, and/or insert the decrypted information into the application object.

Within the group firewall 608, the fraud detection computer system may include a private subnet 622. The private subnet 622 may include ASYNC service, SYNC service, scoring service, master risk database, or any combination thereof. ASYNC service and SYNC service may facilitate requests to be sent to scoring service 630. In particular, ASYNC service may be used for asynchronous communications, as described with the browser interface 602 and the batch interface 604. SYNC service may be used for synchronous communications, as described with the loan origination system 606.

The scoring service 630 may receive additional information from a master risk database. The additional information may include information not associated with the application. For example, the additional information may be associated with other applications to be used for comparison. In one illustrative example, master risk database may be a location where verified incomes related to various occupations, employers, or previous loan applications are stored so they may be analyzed and used by scoring service 630. The scoring service 630 may calculate a fraud risk score. This fraud risk score can include, for example: an income risk score indicative of a likelihood that a stated income in an application is overstated by at least a threshold amount related to a true income; a synthetic identity score, indicating the likelihood of falsely constructed identifying information intended to create an inaccurate or incomplete credit profile for the borrower; a dealer score indicating the likelihood of misrepresentation initiated by the dealer in order to increase the likelihood of sale by making the deal more attractive to the lender than it actually is; a true-name identity fraud score which can be an indication of a likelihood of, for example, identify theft in which someone else's name and identifying information are falsely used; a score indicating the likelihood of significant financial loss due to misrepresentation leading to early payment default; a general fraud score capturing any of multiple types of fraud; and/or an intersection of one or more known fraud types and significant financial loss due to early payment default.

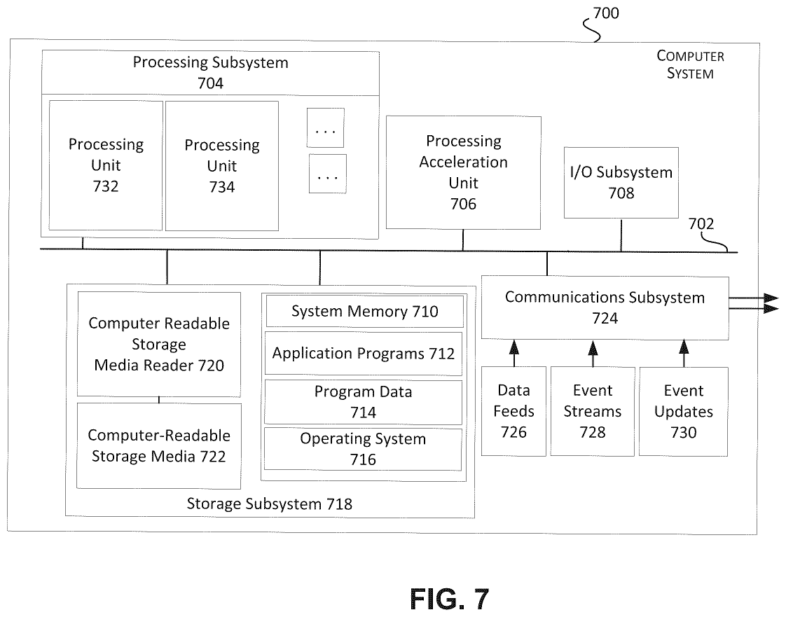

FIG. 7 illustrates an example of a computer system that may be used to implement certain embodiments of the disclosure. For example, in some embodiments, computer system 700 may be used to implement any of the systems, servers, devices, or the like described above. As shown in FIG. 7, computer system 700 includes processing subsystem 704, which communicates with a number of other subsystems via bus subsystem 702. These other subsystems may include processing acceleration unit 706, I/O subsystem 708, storage subsystem 718, and communications subsystem 724. Storage subsystem 718 may include non-transitory computer-readable storage media including storage media 722 and system memory 710.

Bus subsystem 702 provides a mechanism for allowing the various components and subsystems of computer system 700 to communicate with each other. Although bus subsystem 702 is shown schematically as a single bus, alternative embodiments of bus subsystem 702 may utilize multiple buses. Bus subsystem 702 may be any of several types of bus structures including a memory bus or memory controller, a peripheral bus, a local bus using any of a variety of bus architectures, and the like. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which may be implemented as a Mezzanine bus manufactured to the IEEE P1386.1 standard, and the like.

Processing subsystem 704 controls the operation of computer system 700 and may comprise one or more processors, application specific integrated circuits (ASICs), or field programmable gate arrays (FPGAs). The processors may include single core and/or multicore processors. The processing resources of computer system 700 may be organized into one or more processing units 732, 734, etc. A processing unit may include one or more processors, one or more cores from the same or different processors, a combination of cores and processors, or other combinations of cores and processors. In some embodiments, processing subsystem 704 may include one or more special purpose co-processors such as graphics processors, digital signal processors (DSPs), or the like. In some embodiments, some or all of the processing units of processing subsystem 704 may be implemented using customized circuits, such as application specific integrated circuits (ASICs), or field programmable gate arrays (FPGAs).

In some embodiments, the processing units in processing subsystem 704 may execute instructions stored in system memory 710 or on computer readable storage media 722. In various embodiments, the processing units may execute a variety of programs or code instructions and may maintain multiple concurrently executing programs or processes. At any given time, some or all of the program code to be executed may be resident in system memory 710 and/or on computer-readable storage media 722 including potentially on one or more storage devices. Through suitable programming, processing subsystem 704 may provide various functionalities described above. In instances where computer system 700 is executing one or more virtual machines, one or more processing units may be allocated to each virtual machine.

In certain embodiments, processing acceleration unit 706 may optionally be provided for performing customized processing or for off-loading some of the processing performed by processing subsystem 704 so as to accelerate the overall processing performed by computer system 700.

I/O subsystem 708 may include devices and mechanisms for inputting information to computer system 700 and/or for outputting information from or via computer system 700. In general, use of the term input device is intended to include all possible types of devices and mechanisms for inputting information to computer system 700. User interface input devices may include, for example, a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may also include motion sensing and/or gesture recognition devices that enable users to control and interact with an input device and/or devices that provide an interface for receiving input using gestures and spoken commands. User interface input devices may also include eye gesture recognition devices that detects eye activity (e.g., “blinking” while taking pictures and/or making a menu selection) from users and transforms the eye gestures as inputs to an input device. Additionally, user interface input devices may include voice recognition sensing devices that enable users to interact with voice recognition systems through voice commands.

Other examples of user interface input devices include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, and medical ultrasonography devices. User interface input devices may also include, for example, audio input devices such as MIDI keyboards, digital musical instruments and the like.

In general, use of the term output device is intended to include all possible types of devices and mechanisms for outputting information from computer system 700 to a user or other computer system. User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. For example, user interface output devices may include, without limitation, a variety of display devices that visually convey text, graphics and audio/video information such as monitors, printers, speakers, headphones, automotive navigation systems, plotters, voice output devices, and modems.

Storage subsystem 718 provides a repository or data store for storing information and data that is used by computer system 700. Storage subsystem 718 provides a tangible non-transitory computer-readable storage medium for storing the basic programming and data constructs that provide the functionality of some embodiments. Storage subsystem 718 may store software (e.g., programs, code modules, instructions) that, when executed by processing subsystem 704, provides the functionality described above. The software may be executed by one or more processing units of processing subsystem 704. Storage subsystem 718 may also provide a repository for storing data used in accordance with the teachings of this disclosure.

Storage subsystem 718 may include one or more non-transitory memory devices, including volatile and non-volatile memory devices. As shown in FIG. 7, storage subsystem 718 includes system memory 710 and computer-readable storage media 722. System memory 710 may include a number of memories, including (1) a volatile main random access memory (RAM) for storage of instructions and data during program execution and (2) a non-volatile read only memory (ROM) or flash memory in which fixed instructions are stored. In some implementations, a basic input/output system (BIOS), including the basic routines that help to transfer information between elements within computer system 700, such as during start-up, may typically be stored in the ROM. The RAM typically includes data and/or program modules that are presently being operated and executed by processing subsystem 704. In some implementations, system memory 710 may include multiple different types of memory, such as static random access memory (SRAM), dynamic random access memory (DRAM), and the like.

By way of example, and not limitation, as depicted in FIG. 7, system memory 710 may load application programs 712 that are being executed, which may include various applications such as Web browsers, mid-tier applications, relational database management systems (RDBMS), etc., program data 714, and operating system 716.

Computer-readable storage media 722 may store programming and data constructs that provide the functionality of some embodiments. Computer-readable media 722 may provide storage of computer-readable instructions, data structures, program modules, and other data for computer system 700. Software (programs, code modules, instructions) that, when executed by processing subsystem 704 provides the functionality described above, may be stored in storage subsystem 718. By way of example, computer-readable storage media 722 may include non-volatile memory such as a hard disk drive, a magnetic disk drive, an optical disk drive such as a CD ROM, DVD, a Blu-Ray® disk, or other optical media. Computer-readable storage media 722 may include, but is not limited to, Zip® drives, flash memory cards, universal serial bus (USB) flash drives, secure digital (SD) cards, DVD disks, digital video tape, and the like. Computer-readable storage media 722 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs.

In certain embodiments, storage subsystem 718 may also include computer-readable storage media reader 720 that may further be connected to computer-readable storage media 722. Reader 720 may receive and be configured to read data from a memory device such as a disk, a flash drive, etc.

In certain embodiments, computer system 700 may support virtualization technologies, including but not limited to virtualization of processing and memory resources. For example, computer system 700 may provide support for executing one or more virtual machines. In certain embodiments, computer system 700 may execute a program such as a hypervisor that facilitated the configuring and managing of the virtual machines. Each virtual machine may be allocated memory, compute (e.g., processors, cores), I/O, and networking resources. Each virtual machine generally runs independently of the other virtual machines. A virtual machine typically runs its own operating system, which may be the same as or different from the operating systems executed by other virtual machines executed by computer system 700. Accordingly, multiple operating systems may potentially be run concurrently by computer system 700.

Communications subsystem 724 provides an interface to other computer systems and networks. Communications subsystem 724 serves as an interface for receiving data from and transmitting data to other systems from computer system 700. For example, communications subsystem 724 may enable computer system 700 to establish a communication channel to one or more client devices via the Internet for receiving and sending information from and to the client devices.

Communication subsystem 724 may support both wired and/or wireless communication protocols. For example, in certain embodiments, communications subsystem 724 may include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.XX family standards, or other mobile communication technologies, or any combination thereof), global positioning system (GPS) receiver components, and/or other components. In some embodiments, communications subsystem 724 may provide wired network connectivity (e.g., Ethernet) in addition to or instead of a wireless interface.

Communication subsystem 724 may receive and transmit data in various forms. For example, in some embodiments, in addition to other forms, communications subsystem 724 may receive input communications in the form of structured and/or unstructured data feeds 726, event streams 728, event updates 730, and the like. For example, communications subsystem 724 may be configured to receive (or send) data feeds 726 in real-time from users of social media networks and/or other communication services such as web feeds and/or real-time updates from one or more third party information sources.

In certain embodiments, communications subsystem 724 may be configured to receive data in the form of continuous data streams, which may include event streams 728 of real-time events and/or event updates 730, that may be continuous or unbounded in nature with no explicit end. Examples of applications that generate continuous data may include, for example, sensor data applications, financial tickers, network performance measuring tools (e.g. network monitoring and traffic management applications), clickstream analysis tools, automobile traffic monitoring, and the like.

Communications subsystem 724 may also be configured to communicate data from computer system 700 to other computer systems or networks. The data may be communicated in various different forms such as structured and/or unstructured data feeds 726, event streams 728, event updates 730, and the like to one or more databases that may be in communication with one or more streaming data source computers coupled to computer system 700.

Computer system 700 may be one of various types, including a handheld portable device, a wearable device, a personal computer, a workstation, a mainframe, a kiosk, a server rack, or any other data processing system. Due to the ever-changing nature of computers and networks, the description of computer system 700 depicted in FIG. 7 is intended only as a specific example. Many other configurations having more or fewer components than the system depicted in FIG. 7 are possible. Based on the disclosure and teachings provided herein, a person of ordinary skill in the art will appreciate other ways and/or methods to implement the various embodiments.

In the forgoing description, for the purposes of explanation, specific details are set forth in order to provide a thorough understanding of examples of the disclosure. However, it should be apparent that various examples may be practiced without these specific details. For example, circuits, systems, networks, processes, and other components may be shown as components in block diagram form in order to not obscure the examples in unnecessary detail. In other instances, well-known circuits, processes, algorithms, structures, and techniques may have been shown without necessary detail in order to avoid obscuring the examples. The figures and description are not intended to be restrictive.

The description provides examples only, and is not intended to limit the scope, applicability, or configuration of the disclosure. Rather, the description of the examples provides those skilled in the art with an enabling description for implementing an example. It should be understood that various changes may be made in the function and arrangement of elements without departing from the spirit and scope of the disclosure as set forth in the appended claims.

Also, it is noted that individual examples may be described as a process which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination may correspond to a return of the function to the calling function or the main function.

The term “machine-readable storage medium” or “computer-readable storage medium” includes, but is not limited to, portable or non-portable storage devices, optical storage devices, and various other mediums capable of storing, including, or carrying instruction(s) and/or data. A machine-readable storage medium or computer-readable storage medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-program product may include code and/or machine-executable instructions that may represent a procedure, a function, a subprogram, a program, a routine, a subroutine, a module, a software package, a class, or any combination of instructions, data structures, or program statements.

Furthermore, examples may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a machine-readable medium. One or more processors may execute the software, firmware, middleware, microcode, the program code, or code segments to perform the necessary tasks.

Systems depicted in some of the figures may be provided in various configurations. In some embodiments, the systems may be configured as a distributed system where one or more components of the system are distributed across one or more networks such as in a cloud computing system.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The terms and expressions that have been employed in this disclosure are used as terms of description and not of limitation, and there is no intention in the use of such terms and expressions of excluding any equivalents of the features shown and described or portions thereof. It is recognized, however, that various modifications are possible within the scope of the systems and methods claimed. Thus, it should be understood that, although certain concepts and techniques have been specifically disclosed, modification and variation of these concepts and techniques may be resorted to by those skilled in the art, and that such modifications and variations are considered to be within the scope of the systems and methods as defined by this disclosure.

Although specific embodiments have been described, various modifications, alterations, alternative constructions, and equivalents are possible. Embodiments are not restricted to operation within certain specific data processing environments but are free to operate within a plurality of data processing environments. Additionally, although certain embodiments have been described using a particular series of transactions and steps, it should be apparent to those skilled in the art that this is not intended to be limiting. Although some flowcharts describe operations as a sequential process, many of the operations may be performed in parallel or concurrently. In addition, the order of the operations may be rearranged. A process may have additional steps not included in the figure. Various features and aspects of the above-described embodiments may be used individually or jointly.

Further, while certain embodiments have been described using a particular combination of hardware and software, it should be recognized that other combinations of hardware and software are also possible. Certain embodiments may be implemented only in hardware, or only in software, or using combinations thereof. In one example, software may be implemented as a computer program product including computer program code or instructions executable by one or more processors for performing any or all of the steps, operations, or processes described in this disclosure, where the computer program may be stored on a non-transitory computer readable medium. The various processes described herein may be implemented on the same processor or different processors in any combination.

Where devices, systems, components or modules are described as being configured to perform certain operations or functions, such configuration may be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes may communicate using a variety of techniques including but not limited to conventional techniques for inter-process communications, and different pairs of processes may use different techniques, or the same pair of processes may use different techniques at different times.

Specific details are given in this disclosure to provide a thorough understanding of the embodiments. However, embodiments may be practiced without these specific details. For example, well-known circuits, processes, algorithms, structures, and techniques have been shown without unnecessary detail in order to avoid obscuring the embodiments. This description provides example embodiments only, and is not intended to limit the scope, applicability, or configuration of other embodiments. Rather, the preceding description of the embodiments will provide those skilled in the art with an enabling description for implementing various embodiments. Various changes may be made in the function and arrangement of elements.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific embodiments have been described, these are not intended to be limiting. Various modifications and equivalents are within the scope of the following claims.

What is claimed is:

1. A method for computing an application score, the method comprising:
receiving, by a computer system, an application object for an application, and wherein the application object includes application data associated with a first borrower;
extracting information from the application;
capturing features from pooled data across time and lenders;
ingesting the captured features into a Recurrent Neural Network (“RNN”);
generating a preliminary risk score with the RNN based on the ingested captured features;
scaling the preliminary risk score to a range of application scores to determine the application score for the application;
determining one or more reason codes for the application based at least in part on the application score for the application; and
providing the application score and the one or more reason codes to a dealer user device or a lender user device.

2. The method of claim 1, wherein the RNN comprises a Long Short-Term Memory (LSTM) model.

3. The method of claim 2, wherein the LSTM model comprises a forward-only LSTM model processing applications in order from least recent to most recent.

4. The method of claim 3, wherein the LSTM model comprises 5 layers.

5. The method of claim 4, wherein the LSTM model comprises an LSTM layer having 128 nodes.

6. The method of claim 1, wherein the RNN comprises a deep learning Neural Network.

7. The method of claim 6, further comprising receiving the pooled data.

8. The method of claim 7, further comprising matching data for common individuals across time and across multiple lenders in the pooled data.

9. The method of claim 8, wherein matching data for common individuals across time and across multiple lenders in the pooled data is performed by a second machine learning model.

10. The method of claim 8, wherein matching data for common individuals across time and across multiple lenders in the pooled data utilizes multiple alternative matching criteria thereby creating inexact matches between one or more data elements.

11. The method of claim 1, wherein capturing features from pooled data across time and lenders comprises generating a vector for each previous application identified for the first borrower in the pooled data.

12. The method of claim 11, wherein the vectors for the first borrower are arranged in a matrix.

13. The method of claim 12, wherein the matrix can comprise up to a maximum number of vectors.

14. The method of claim 13, wherein vectors associated with the first borrower and meeting selection criteria are added to the matrix.

15. The method of claim 14, wherein ingesting the captured features into a RNN comprises ingesting the vectors one-at-a-time into the RNN.

16. The method of claim 15, wherein the vectors are ingested into the RNN in a reverse sequence.

17. The method of claim 11, wherein the vector comprises a feature characterizing a time between the present application and between each previous application.

18. The method of claim 11, wherein the vector includes at least one feature that is not future-oriented.

19. A system for computing an application score, the system comprising:
one or more processors; and
a non-transitory computer-readable medium including instructions that, when executed by the one or more processors, cause the one or more processors to perform operations comprising:
receiving an application object for an application, and wherein the application object includes application data associated with a first borrower;
extracting information from the application;
capturing features from pooled data across time and lenders;
ingesting the captured features into a Recurrent Neural Network (“RNN”);
generating a preliminary risk score with the RNN based on the ingested captured features;
scaling the preliminary risk score to a range of application scores to determine the application score for the application;
determining one or more reason codes for the application based at least in part on the application score for the application; and
providing the application score and the one or more reason codes to a dealer user device or a lender user device.

20. The system of claim 19, wherein the operation further comprises:
receiving the pooled data; and
matching data for common individuals across time and across multiple lenders in the pooled data, wherein at least one of: matching data for common individuals across time and across multiple lenders in the pooled data is performed by a second machine learning model; or matching data for common individuals across time and across multiple lenders in the pooled data utilizes multiple alternative matching criteria thereby creating inexact matches between one or more data elements.
